(19) United States
(12) Patent Application Publication
(10) Pub. No.: US 2016/0375653 A1
(43) Pub. Date: Dec. 29, 2016

(54) INTEGRATED CIRCUIT DIE TRANSPORT APPARATUS AND METHODS

(71) Applicant: Intel Corporation, Santa Clara, CA (US)

(72) Inventors: Wen Yin, Chandler, AZ (US); Dingying Xu, Chandler, AZ (US); Luyin Zhao, Phoenix, AZ (US)

(21) Appl. No.: 14/752,720

(22) Filed: Jun. 26, 2015

(51) Int. Cl. B32B 7/12; B32B 37/12

(52) U.S. Cl. CPC B32B 7/12; B32B 37/12; B32B 2457/08

(57) ABSTRACT

Die transport apparatus and methods are disclosed herein. In some embodiments, a die transport apparatus may include: a plurality of regularly arranged adhesive areas, wherein individual adhesive areas have a die contact surface; and a relief area recessed from the die contact surfaces. Other embodiments may be disclosed and/or claimed.

### TECHNICAL FIELD

The present disclosure relates generally to the field of integrated circuit (IC), and more particularly, to IC die transport apparatus and methods.

### BACKGROUND

Tape and reel systems for transporting integrated circuit (IC) dies typically involve positioning a die in a pocket of a carrier tape. The pockets are shaped specifically to match the form factor of the dies therein, and the carrier tape is sealed with a cover tape to keep the dies contained.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a top view of a die transport apparatus, in accordance with various embodiments.

FIG. 2 is a side, cross-sectional view of the die transport apparatus of FIG. 1, in accordance with various embodiments.

FIG. 3 is a top view of a transport arrangement including the die transport apparatus of FIG. 1, in accordance with various embodiments.

FIG. 4 is a side, cross-sectional view of the transport arrangement of FIG. 3, in accordance with various embodiments.

FIGS. 5-10 are side, cross-sectional views of various embodiments of the die transport apparatus of FIG. 1.

FIG. 11 is a top view of a die transport apparatus, in accordance with various embodiments.

FIG. 12 is a side, cross-sectional view of a die transport apparatus, in accordance with various embodiments.

FIGS. 13-16 are side, cross-sectional views of assemblies at various stages in the manufacture of an embodiment of the die transport apparatus of FIG. 5, in accordance with various embodiments.

FIGS. 17-19 are side, cross-sectional views of assemblies at various stages in the manufacture of an embodiment of the die transport apparatus of FIG. 8, in accordance with various embodiments.

FIGS. 20-22 are side, cross-sectional views of various stages of operation in a method of processing an IC die, in accordance with various embodiments.

FIG. 23 is a flow diagram of a method of processing an IC die, in accordance with various embodiments.

FIG. 24 is a flow diagram of a method of manufacturing a die transport apparatus, in accordance with various embodiments.

### DETAILED DESCRIPTION

Die transport apparatus and methods are disclosed herein. For example, in some embodiments, a die transport apparatus may include: a plurality of regularly arranged adhesive areas, wherein individual adhesive areas have a die contact surface; and a relief area recessed from the die contact surfaces.

Various ones of the embodiments disclosed herein may be particularly useful for bare die transportation and storage where existing technologies have failed. In particular, the rising demand for small electronic devices (e.g., smartphones, tablets, and wearables) has driven the development of low packaging and three dimensional stacking packaging. However, as chips grow thinner and increasingly complex, they may become more vulnerable during handling and transportation. Previously adequate conventional approaches to die handling, such as tape and reel, may experience multiple different failure modes as chips grow thinner.

One such failure mode may be referred to as “die migration” or “die out-of-pocket.” Die migration may occur when the carrier tape experiences vibration or shock during transportation. If there is enough space between the carrier tape and the cover tape, the dies may migrate out of the pocket through the gap between the carrier tape and the cover tape (and possibly get stuck between the carrier tape and the cover tape outside of the pocket). The likelihood of die migration increases as the height of the die decreases (due to the increased ability for the die to fit between the carrier tape and the cover tape outside of the pocket). The result may be significant downstream yield loss.

Another failure mode is die damage (e.g., die crack). Die damage may occur as the die is jostled against the carrier tape and the cover tape during transport. The damage may also occur when the die is “tilted” in the pocket (instead of sitting “flat”) and a chip attach module feeder attempts to engage and pick the die during assembly; the impact between the chip attach module feeder in the improperly positioned die may lead to die damage.

Conventional transportation and storage techniques may also be not adequate for the next generation of chip testing technology. For example, testing dies after they have been singulated from a wafer (referred to herein as “singulated die testing”), rather than when the dies are still joined at the wafer level (referred to herein as “wafer-level testing”), may be less expensive (since entire wafers need not be handled during testing) and more precise (because dies can be evaluated and rejected/accepted individually). However, some singulated die testing techniques may require open and random access to dies during processing so that a component placement system (e.g., a tape and reel die sort (TRDS) system) can pick and re-pick the same die for multiple tests without having to repeatedly peel and reseal a cover tape covering multiple dies.

Moreover, as noted above, conventional tape and reel systems and other conventional pocketed media, such as Joint Electronic Device Engineering Council (JEDEC) trays and waffle packs, include pockets for dies that are sized specifically for dies of a particular form factor. Each new or different die form factor thus requires a new pocketed media design and corresponding material development, tooling, material management, and training.

Various ones of the embodiments disclosed herein provide a “pocketless” transport apparatus which can accommodate substantially all die footprints and thicknesses. Use of such embodiments may not only substantially reduce the costs associated with introducing new and different dies to a manufacturing process, but may also enable the use of more advanced and precise testing techniques to improve manufacturing efficiency and yield.

Various embodiments of the apparatus disclosed herein may include an open and uniform surface to accommodate a wide range of die footprints and thicknesses so the apparatus is not specific to a particular die size. Dies may be randomly accessed without having to peel away a cover tape, and a single die can be picked and placed multiple times, providing process flexibility. Various embodiments disclosed herein may be picked and re-picked more than 250 times without exhibiting any degradation of the die transport apparatus. Various embodiments of the material adhesion and surface geometry for the apparatus disclosed herein may enable the apparatus to hold dies securely “horizontally” while releasing the die relatively easily when a component placement system applies a “vertical” picking force. Because the dies are adhesively fixed to the apparatus, the die crack and die migration risk associated with thin dies is mitigated or eliminated. Additionally, various embodiments of the apparatus disclosed herein may be cleanable and/or reusable, reducing the waste associated with disposable tape and reel systems.

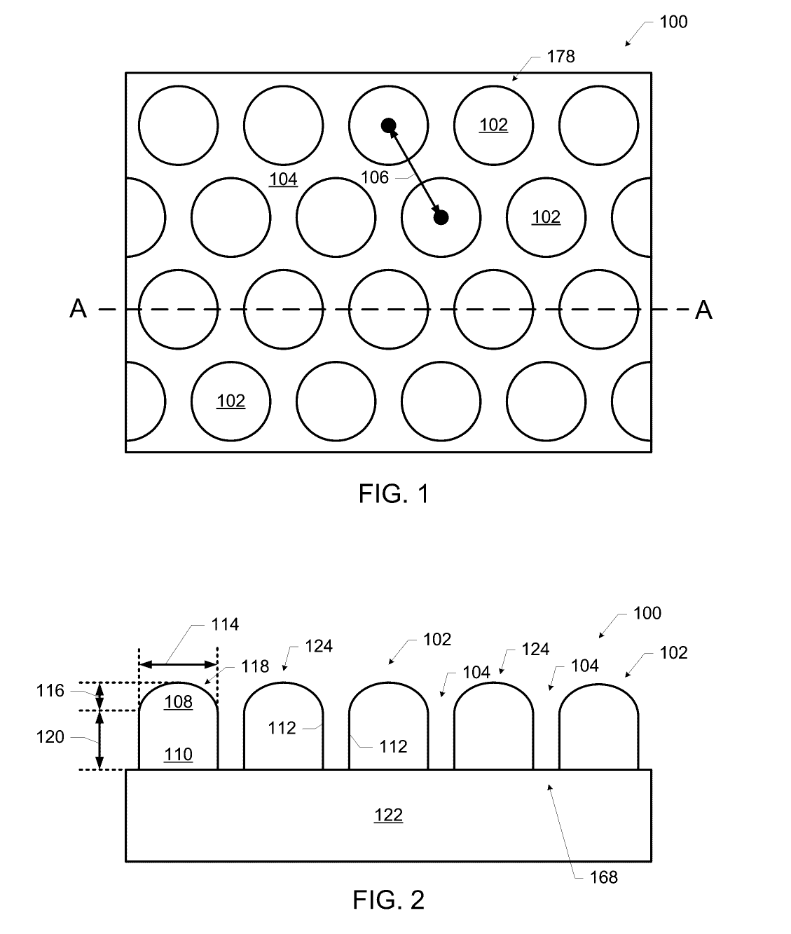

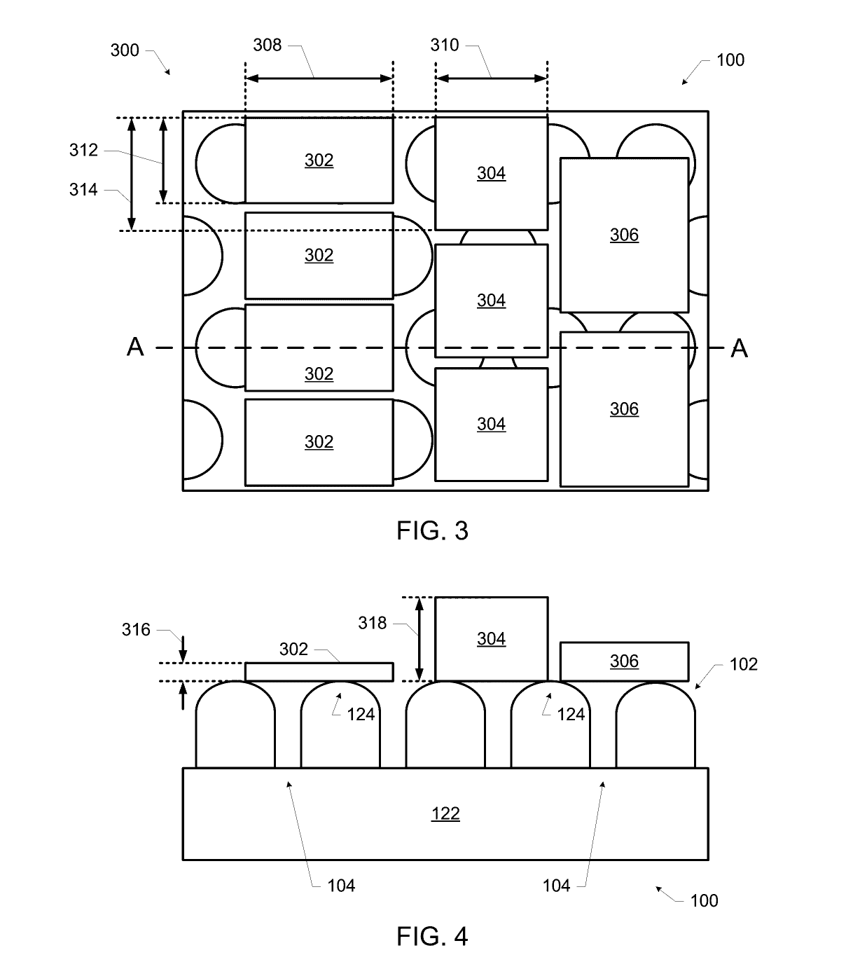

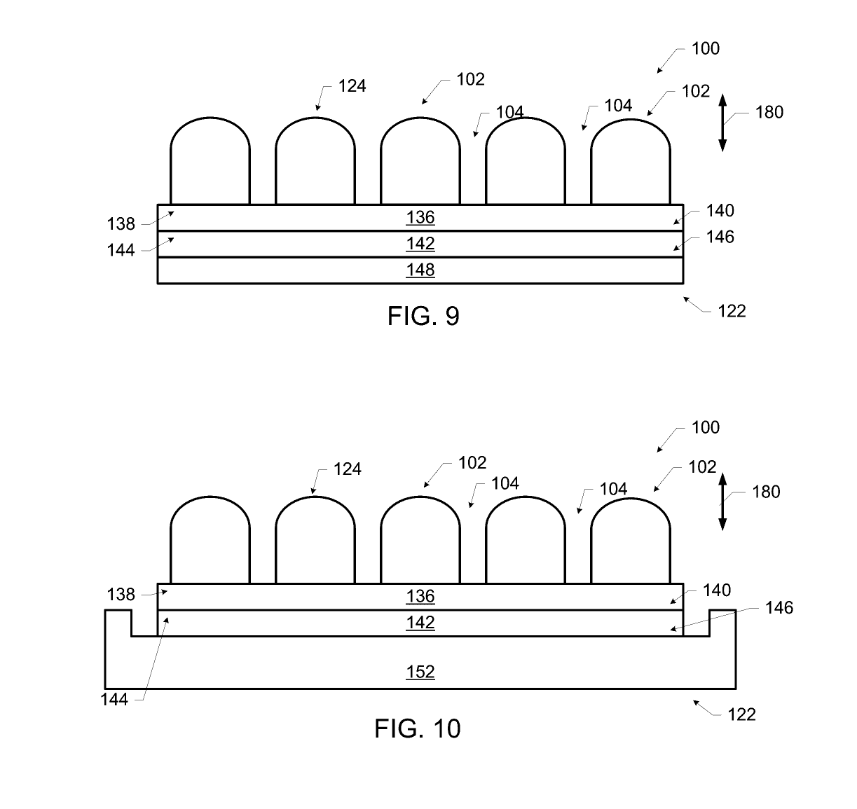

FIG. 1 is a top view of a die transport apparatus 100, and FIG. 2 is a side, cross-sectional view of the die transport apparatus 100 of FIG. 1 (along the section A-A), in accordance with various embodiments. The die transport apparatus 100 may include multiple adhesive areas 102 and a relief area 104. Each individual adhesive area 102 may include a die contact surface 124. The relief area 104 may be recessed from the die contact surfaces 124 (e.g., as illustrated in FIG. 2). In some embodiments, the relief area 104 may be adhesive. In other embodiments, the relief area 104 may not be adhesive. The die transport apparatus 100 may include a base 122 which may have an upper surface 168 that serves as the relief area 104. A number of embodiments of the base 122 are discussed herein (e.g., with reference to FIGS. 5-10).

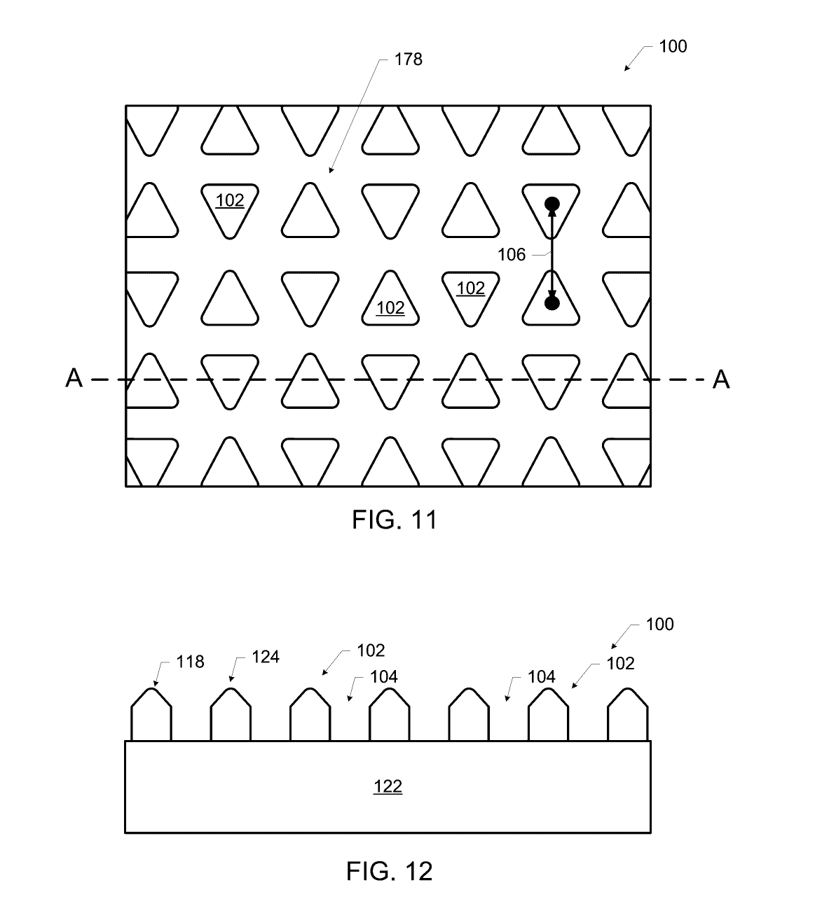

In some embodiments, the adhesive areas 102 may be regularly arranged. For example, in the embodiment illustrated in FIG. 1, the adhesive areas 102 are hexagonally arranged. Other regular arrangements may also be used (e.g., the rectangular arrangement depicted in FIG. 11). The footprints 178 of the adhesive areas 102 illustrated in FIG. 1 are shaped as circles, but this is simply illustrative, and any desired shape may be used for the footprints 178 (e.g., a rounded polygon, a ring, or any other complex or simple, convex and concave shape). For example, FIG. 11 depicts an embodiment of the die transport apparatus 100 in which the adhesive areas 102 have footprints 178 that are triangular. The adhesive areas 102 may have a matte or rough finish, a smooth finish, or any combination of finishes. The materials used for the die transport apparatus 100 may not leave any significant adhesive residue on the dies transported by the die transport apparatus 100. The adhesive areas 102 may be formed of any suitable adhesive material, such as a thermoplastic elastomer (TPE). In particular, the adhesive areas 102 may be formed of any of the adhesive materials discussed below with reference to the continuous adhesive material 130.

The dimensions of the footprints 178 of the adhesive areas 102 and the spacing between adhesive areas 102 may take any suitable values. For example, the spacing between adhesive areas 102 may be selected based on the size of the dies that will be transported by the die transport apparatus 100 so that a die disposed on transport apparatus 100 will contact two or more die contact surfaces 124. In some embodiments, a center of an adhesive area 102 may be spaced away from a center of a nearest neighbor adhesive area by a distance 106 between 0.5 millimeters and 3 millimeters.

Although FIG. 1 depicts an embodiment of the die transport apparatus 100 with adhesive areas 102 having footprints 178 that are all the same shape, this need not be the case. In some embodiments, the adhesive areas 102 included in the die transport apparatus 100 may have footprints 178 that are differently shaped from each other. For example, a die transport apparatus 100 may have some adhesive areas 102 having footprints 178 shaped as shown in FIG. 1 and may have other adhesive areas 102 having footprints 178 shaped as shown in FIG. 11. Additionally, although the relief area 104 of the die transport apparatus 100 of FIG. 1 is shown as a continuous area, this need not be the case. In some embodiments, a die transport apparatus 100 may include a plurality of non-contiguous relief areas 104 recessed from the die contact surfaces 124 of the adhesive areas 102.

In some embodiments, individual adhesive areas 102 may have a profile with a curved portion. For example, the individual adhesive areas 102 of the die transport apparatus 100 depicted in FIG. 2 may have a curved portion 118. The curved portion 118 may have a height 116 that may take any suitable value. For example, in some embodiments, the height 116 of the curved portion 118 may be between 25 microns and 150 microns. The curved portion 118 may have a width 114 that may take any suitable value. For example, in some embodiments, the width 114 may be between 0.5 millimeters and 2 millimeters. The curved portion 118 may have any suitable profile, such as a semi-circular profile, a semi-elliptical profile, or any other curved profile.

In some embodiments, the curved portion 118 of the adhesive areas 102 may be an upper portion of a profile of the adhesive areas 102. For example, in the embodiment of the die transport apparatus 100 illustrated in FIG. 2, the curved portion 118 may be an upper portion 108 and the profile of the adhesive areas 102 may also include a lower portion 110. The lower portion 110 may include side walls 112. As illustrated in FIG. 2, in some embodiments, the side walls 112 may be vertical; in other embodiments, the side walls 112 may not be vertical, and instead may be angled and/or curved. The side walls 112 may have a height 120 that may take any suitable value. For example, in some embodiments, the height 120 may be between 25 microns and 150 microns. In some embodiments, no lower portion 110 may be present, and the curved portion 118 may extend directly from the relief area 104.

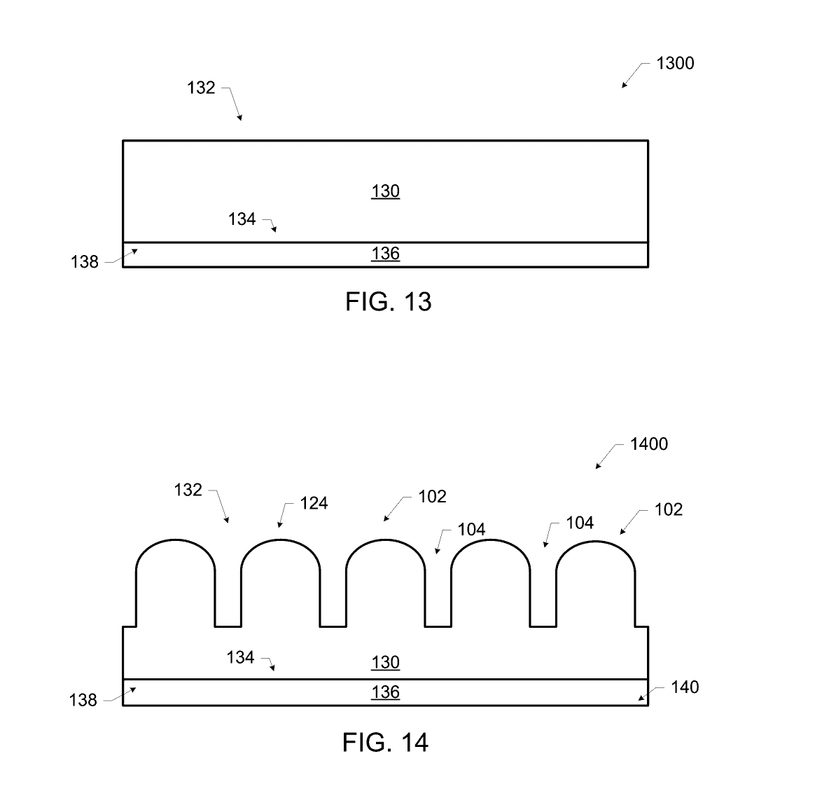

Although FIG. 2 depicts an embodiment of the die transport apparatus 100 with adhesive areas 102 having profiles that are all the same shape, this need not be the case. In some embodiments, the adhesive areas 102 included in the die transport apparatus 100 may have profiles that are differently shaped from each other. For example, a die transport apparatus 100 may have some adhesive areas 102 having profiles shaped as shown in FIG. 2 and may have other adhesive areas 102 having profiles shaped as shown in FIG. 12.

As discussed above, the dimensions of various components of the die transport apparatus may be selected to take any suitable values. For example, in some embodiments, the curved portion 118 may have the shape of the top half of an ellipse, the width 114 may be 1.2 millimeters, the height 120 may be 75 microns, the height 116 may be 75 microns, and the distance 106 may be 2 millimeters. In another example, the curved portion 118 may have the shape of the top half of an ellipse, the width 114 may be 1.2 millimeters, the height 120 may be 75 microns, the height 116 may be 75 microns, and the distance 106 may be 1.5 millimeters. In another example, the curved portion 118 may have the shape of the top half of an ellipse, the width 114 may be 0.8 millimeters, the height 120 may be 75 microns, the height 116 may be 75 microns, and the distance 106 may be 1.5 millimeters. In another example, the curved portion 118 may have the shape of the top half of an ellipse, the width 114 may be 0.8 millimeters, the height 120 may be 75 microns, the height 116 may be 75 microns, and the distance 106 may be 1.1 millimeters. These are simply examples, and other suitable dimensions may be used.

The selection of a profile for an adhesive area may depend on the amount and distribution of force desired on the dies transported by the die transport apparatus 100. Having a curved portion 118 for the die contact surface 124 of an adhesive area 102 (e.g., a concave curvature) may result in a reduced contact area between the die contact surface 124 and a die relative to an adhesive area with a broad “flat” die contact surface 124. Additionally, the maximum contact area between the die transport apparatus 100 and a transported die is limited because the relief area 104 is recessed away from the die during transport, and thus is not in contact with the die. Since the area of contact between a die and the die transport apparatus 100 is limited to a die contact surface 124 of desired geometry, the maximum adhesion between the die and the die transport apparatus 100 is also limited. The amount of force applied to a die during picking may be adjusted by changing the acceleration with which the die is picked (with higher accelerations corresponding to higher pick forces, but reduced process time). Example accelerations may be between 1000 millimeters per squared second and 12000 millimeters per squared second.

This selective contact between the die and the die transport apparatus 100 avoids the continuous wetting across the whole die that would occur if the die were placed on a continuous “flat” adhesive surface. If the die were in continuous “flat” contact with an adhesive, the picking force applied to the die by a component placement system when the die is picked up is distributed over the entire adhesive area and debonding only occurs when a “crack” unpredictably occurs between the die and the adhesive surface. Debonding in such a scenario is, therefore, unpredictable and difficult, and existing technologies that utilize adhesion (such as die picking from a mylar dicing tape) typically employ an additional release mechanism, such as using a die ejector to “poke” the tape from underneath the die while vacuum is applied to the dicing tape is partially delaminated from the die to facilitate pick up of the die via the vacuum nozzle.

When the adhesive contact surface is “patterned” as discussed herein with reference to the adhesive areas 102 and the relief area 104, the initial debonding crack is hardwired into the design and occurs at an edge of the contact area between the die and the adhesive areas 102. The picking force applied to the die is, therefore, concentrated into the crack region, leading to a well-controlled debonding process. The use of the apparatus and methods disclosed herein may provide improved debonding performance relative to conventional continuous wetting approaches in a manner analogous to the ease with which a piece of adhesive tape may be removed from a surface by peeling from an end relative to pulling the adhesive tape vertically from the middle.

In use, one or more dies may be disposed on the die transport apparatus 100 such that each individual die is in contact with one or more of the die contact surfaces 124 of the adhesive areas 102 but are not in contact with the relief area 104. The strength of the adhesive of the die contact surfaces 124 may be high enough to substantially prevent lateral and vertical movement of one or more dies during transport, but may be low enough to permit one or more dies to be removed from the die transport apparatus 100 by a component placement system (e.g., a pick-and-place machine or other piece of die handling manufacturing equipment. The strength of the adhesive of the adhesive areas 102 may be characterized by the peak tack force of the adhesive. In some embodiments, the individual adhesive areas 102 may have a peak tack force between 15 and 150 grams. In some embodiments, the individual adhesive areas 102 may have a peak tack force between 30 and 100 grams.

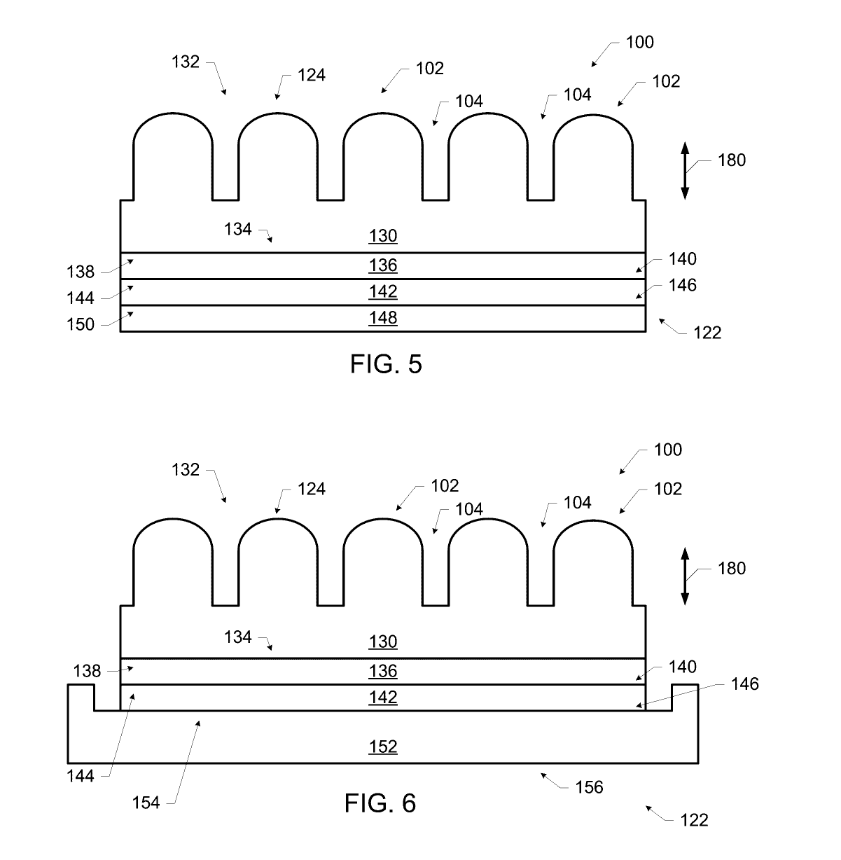

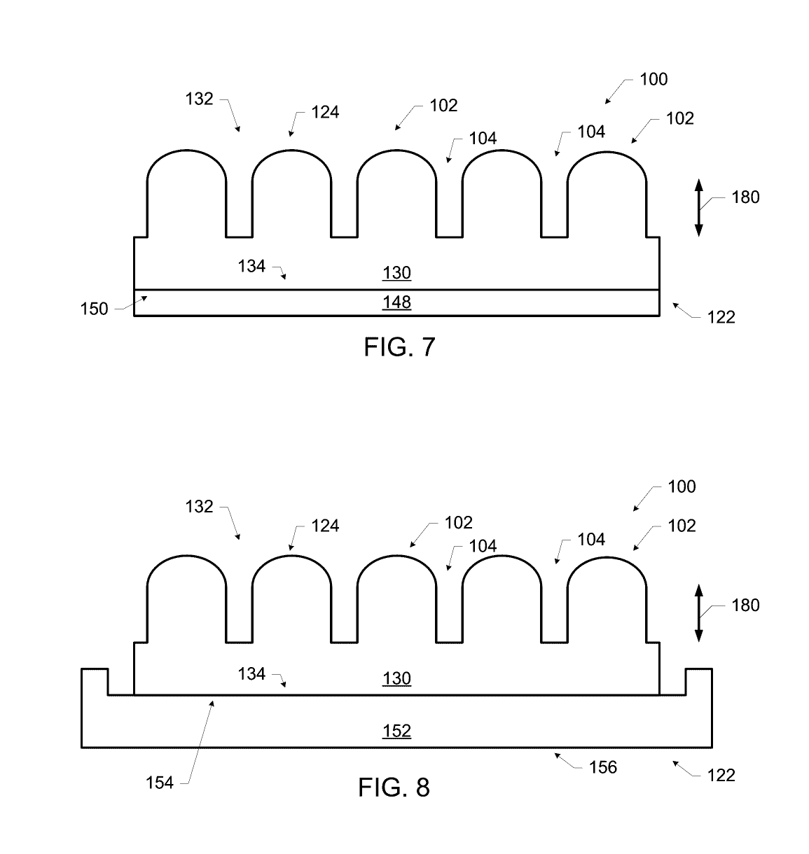

FIG. 3 is a top view of a transport arrangement 300 including the die transport apparatus 100 of FIG. 1, and FIG. 4 is a side, cross-sectional view of the transport arrangement 300, in accordance with various embodiments. In particular, the transport arrangement 300 includes multiple first dies 302 (all having a common form factor), multiple second dies 304 (all having a common form factor that is different from the form factor of the first dies 302), and multiple third dies 306 (all having a common form factor that is different from the form factors of the first dies 302 and the second dies 304). In particular, the first die 302 may have a width 308, a length 312, and a height 316, while the second die 304 may have a width 310, a length 314, and a height 318. The width 308 may be different from the width 310, the length 312 may be different from the length 314, and/or the height 316 may be different from the height 318. Each of the first dies 302, second dies 304, and third dies 306 may be in contact with one or more die contact surfaces 124 of the adhesive areas 102, and may be spaced away from the relief area 104. Although examples of dies having three different form factors are illustrated in FIGS. 3 and 4, the die transport apparatus 100 may be used to transport one or more dies having a single form factor or any number of form factors.

As indicated above, the base 122 of the die transport apparatus 100 may take any of a number of forms. FIGS. 5-10 are side, cross-sectional views of various embodiments of the die transport apparatus 100 of FIGS. 1 and 2, and in particular, various embodiments of the base 122.

In the embodiment of the die transport apparatus 100 depicted in FIG. 5, the base 122 includes a portion of a continuous adhesive material 130 that also provides the adhesive areas 102 and the relief area 104. In this embodiment, the relief area 104 is adhesive. The base 122 may further include a support film 136, a second adhesive material 142, and a release liner 148, arranged in a stack in the direction indicated by the axis 180. In particular, the continuous adhesive material 130 may have a first face 132 and a second face 134 opposite the first face 132. The adhesive areas 102 may be located at the first face 132 and a first face 138 of the support film 136 may be coupled to the second face 134 of the continuous adhesive material 130. The support film 136 may have a second face 140 opposite to the first face 138, and the second face 140 may be coupled to a first face 144 of the second adhesive material 142. The second adhesive material 142 may have a second face 146 opposite to the first face 144, and the second face 146 may be coupled to a first face 150 of the release liner 148. The release liner 148 may be formed from any suitable material, such as a polyester.

In some embodiments, the continuous adhesive material 130 may be formed of TPE. Material properties of the continuous adhesive material 130 may be selected as suitable. For example, in some embodiments, the continuous adhesive material 130 may have a tensile strength between 7 and 10 megaPascals, and a hardness of 29 to 39 shore A. In some embodiments in which the continuous adhesive material is formed of TPE, the TPE may include styrene ethylene butylene styrene (SEBS), polyolefin (PO), and/or mineral oil.

In embodiments including the support film 136, the support film 136 may provide mechanical support for the adhesive material on “top” of the support film 136. In some embodiments, the adhesive material may be relatively elastic on its own (e.g., “rubbery”), and the support film 136 may be “rigid” enough to mechanically support the adhesive material to keep the adhesive material from deforming as it is handled and as forces are applied. The support film 136 may be formed of any suitable material, such as polyethylene terephthalate (PET) and/or PET/polyethylene (PE) dual layer with PE as an adhesion promoter (PE). The support film 136 may have any suitable thickness. For example, in some embodiments, the support film 136 may have a thickness of approximately 4.3 thousandths of an inch (e.g., +/−.2 millimeters).

In embodiments including the second adhesive material 142, the second adhesive material 142 may couple two non-adhesive surfaces together. For example, as discussed below with reference to FIG. 6, the second adhesive material 142 may couple the support film 136 to a non-adhesive tray 152. The release liner 148 may be used to prevent the second adhesive material 142 of the die transport apparatus 100 from inadvertently sticking to other surfaces, and may be readily removed if the second adhesive material 142 is to be coupled to another surface. The second adhesive material 142 may be, for example, a pressure sensitive adhesive (PSA), such as a low outgassing bonding tape or acrylic adhesive. The second adhesive material 142 may have any suitable thickness. For example, in some embodiments, the second adhesive material 142 may have a thickness of approximately 5 thousandths of an inch (e.g., +/−.2 millimeters). Other material properties of the second adhesive material 142 may be selected as suitable. For example, the second adhesive material 142 may have an adhesive peel force of 30-100 ounces per inch.

FIG. 6 depicts an embodiment of the die transport apparatus 100 that is similar to the embodiment of the die transport apparatus 100 illustrated in FIG. 5, but the release liner 148 of the embodiment of FIG. 5 has been replaced by a tray 152. In particular, the second face 146 of the second adhesive material 142 may be coupled to a first face 154 of a tray 152. The die transport apparatus 100 of FIG. 5 may be modified to form the die transport apparatus of FIG. 6 by removing the release liner 148 from the die transport apparatus 100 of FIG. 5 and coupling the second adhesive material 142 to the tray 152 (e.g., by lamination).

The tray 152 may take any suitable form for use in die transport and storage applications. For example, in some embodiments, the tray 152 may be formed from a polycarbonate material (e.g., a carbon nanotube material). For example, the tray 152 may be a carbon nanotube reinforced polycarbonate, which may be selected based on a mechanical strength requirements of the tray 152 and/or an electrostatic discharge (ESD) requirement. The tray 152 may be substantially rigid and may be formed of materials that do not significantly flake during handling. The tray 152 may also be electrically passive so that it does not store static electricity that may discharge and damage the dies transported by the die transport apparatus 100. In some embodiments, the tray 152 may have the dimensions of existing trays used in die handling systems to facilitate the use of the die transport apparatus 100 in legacy systems. For example, the tray 152 may be a JEDEC tray.

FIG. 7 depicts an embodiment of the die transport apparatus 100 that is similar to the embodiment of the die transport apparatus 100 illustrated in FIG. 5, but no support film 136 or second adhesive material 142 is included. Instead, the second face 134 of the continuous adhesive material 130 is coupled to the first face 150 of the release liner 148.

FIG. 8 depicts an embodiment of the die transport apparatus 100 that is similar to the embodiment of the die transport apparatus 100 illustrated in FIG. 7, but the release liner 148 of the embodiment of FIG. 7 has been replaced by a tray 152. In particular, the second face 134 of the continuous adhesive material 130 may be coupled to the first face 154 of the tray 152. Such embodiments may be appropriate when the continuous adhesive material 130 has adequate adhesion to be secured directly to the tray 152 without debonding from the tray 152 as dies are picked from the die transport apparatus 100. Such an embodiment may have a simplified structure relative to some of the other die transport apparatus 100 disclosed herein and may be manufactured at a reduced cost.

FIG. 9 depicts an embodiment of the die transport apparatus 100 in which the adhesive material providing the adhesive areas 102 is different from a support film 136 providing the relief area 104. In particular, portions of adhesive material may be disposed on the support film 136 to form the adhesive areas 102. In such an embodiment, the relief area 104 will not be adhesive if the support film 136 is not adhesive, and vice versa. In the embodiment of FIG. 9, the base 122 may include the support film 136, the second adhesive material 142, and the release liner 148, arranged as discussed above with reference to FIG. 5.

FIG. 10 depicts an embodiment of the die transport apparatus 100 that is similar to the embodiment of the die transport apparatus 100 illustrated in FIG. 9, but the release liner 148 of the embodiment of FIG. 9 has been replaced by a tray 152. In particular, the second face 146 of the second adhesive material 142 may be coupled to the first face 154 of the tray 152.

As noted above, the footprints 178 of the adhesive areas 102 may take any suitable shape. For example, FIG. 11 is a top view of a die transport apparatus 100 having adhesive areas 102 with triangular footprints 178, in accordance with various embodiments. As noted above with reference to FIG. 1, the dimensions of the footprints 178 of the adhesive areas 102 and the spacing between adhesive areas 102 may take any suitable values. In some embodiments, a center of an adhesive area 102 may be spaced away from a center of a nearest neighbor adhesive area by a distance 106 between 0.5 millimeters and 3 millimeters. In some embodiments, the footprints 178 of the adhesive areas 102 may not be circles or polygons, but instead may be stripes of adhesive areas 102. In some embodiments, the adhesive areas 102 may be distributed in a grid arrangement of stripes.

As noted above, the profiles of the adhesive areas 102 may take any suitable shape. For example, FIG. 12 is a side, cross-sectional view of a die transport apparatus 100 (e.g., the die transport apparatus 100 of FIG. 9 along the section A-A) having profiles with a curved portion 118 of the die contact surfaces 124 that is more “peaked” than the curved portion 118 of the die contact surfaces 124 of the embodiment of FIG. 2.

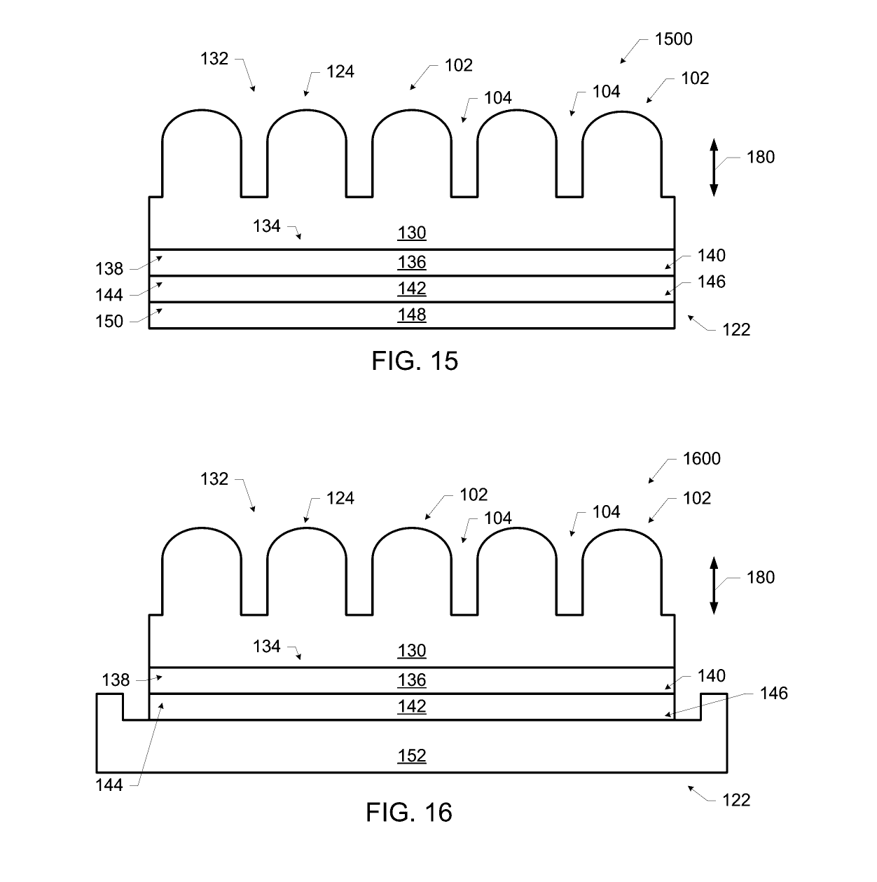

FIGS. 13-16 are side, cross-sectional views of the assemblies at various stages in the manufacture of an embodiment of the die transport apparatus 100 of FIG. 5, in accordance with various embodiments. Although the stages illustrated by FIGS. 13-16 are shown as producing the die transport apparatus 100 of FIG. 5, this is simply illustrative, and the operations discussed below with reference to FIGS. 13-16 may be used to manufacture any suitable die transport apparatus. Additionally, although the various manufacturing operations discussed below with reference to FIGS. 13-16 are discussed in a particular order, the manufacturing operations may be performed in any suitable order.

FIG. 13 depicts an assembly 1300 having a continuous adhesive material 130 coupled to a support film 136. In particular, the continuous adhesive material 130 has a first face 132 and the second face 134 opposite the first face 132. The second face 134 of the continuous adhesive material 130 may be coupled to a first face 138 of the support film 136. The support film 136 may also have a second face 140 opposite to the first face 138. In the assembly 1300, the continuous adhesive material 130 may be a substantially flat sheet having any suitable thickness.

FIG. 14 depicts the assembly 1400 subsequent to patterning the first face 132 of continuous adhesive material 130 of the assembly 1300 with multiple regularly arranged adhesive areas 102 and a relief area 104 (e.g., as discussed above with reference to FIGS. 1, 2, and 5). In some embodiments, patterning the continuous adhesive material 130 may be performed by embossing a texture onto the first face 132 of the continuous adhesive material 130 of the assembly 1300. An extruder machine may be used to perform this process and may include a roller that embosses the texture onto a sheet of the continuous adhesive material 130 as the continuous adhesive material 130 cools. In some embodiments, the operations discussed above with reference to FIGS. 13 and 14 may be combined, and the continuous adhesive material 130 may be extruded onto the support film 136. The continuous adhesive material 130 may have a thickness after patterning of approximately 12 to 15 thousandths of an inch (e.g., +/−0.4 millimeters).

FIG. 15 depicts the assembly 1500 subsequent to coupling the assembly 1400 to a second adhesive material 142 and a release liner 148. In particular, the patterned continuous adhesive material 130 of the assembly 1400 may be coupled to the second adhesive material 142 via the support film 136. The support film 136 may have a first face 138 and a second face 140 opposite to the first face 138, and the second face 140 may be coupled to a first face 144 of the second adhesive material 142. The second adhesive material 142 may have a second face 146 opposite to the first face 144, and the second face 146 may be coupled to a first face 150 of the release liner 148. The second adhesive material 142 may have any suitable thickness, such as approximately 5 thousandths of an inch (e.g., +/−0.2 millimeters). In some embodiments, coupling the patterned continuous adhesive material 130 of the assembly 1400 to the second adhesive material 142 and the release liner 148 may be performed during a double-sided conversion process. The conversion process may also include cutting the assembly 1500 into sheets that are sized for lamination onto a tray 152, as discussed below with reference to FIG. 16. The dimensions of these cut sheets may be selected to match the dimensions of the tray 152. The assembly 1500 and components thereof may take any of the forms discussed above with reference to the die transport apparatus 100 of FIG. 5.

In some embodiments, the assembly 1500 may further include a coversheet to protect the continuous adhesive material 130 after manufacture but prior to use in transporting dies. The coversheet may be formed of any suitable material, such as PET.

FIG. 16 depicts the assembly 1600 subsequent to removing the release liner 148 from the assembly 1500 and coupling the remainder of the assembly 1500 to a tray 152. In particular, a second face 146 of the second adhesive material 142 may be coupled to a first face 154 of the tray 152 to laminate the second adhesive material 142 onto the tray 152. In some embodiments, the assembly 1500 may include an extra “tab” of the release liner 148 that can be grasped to facilitate removing the release liner 148 from the assembly 1500. The assembly 1600 and components thereof may take any of the forms discussed above with reference to the die transport apparatus 100 of FIG. 6.

In some embodiments, the die transport apparatus 100 of FIG. 7 may be manufactured by performing the operations discussed above with reference to FIGS. 13 and 14; the assembly 1400 may provide the die transport apparatus 100 of FIG. 7. In some embodiments, the die transport apparatus 100 of FIG. 880 manufactured by performing the operations discussed above with reference to FIGS. 13, 14, and 16, omitting the second adhesive material 142 and the release liner 148, and removing the support film 136 from the patterned continuous adhesive material 130 before coupling the patterned continuous adhesive material 130 directly to the tray 152.

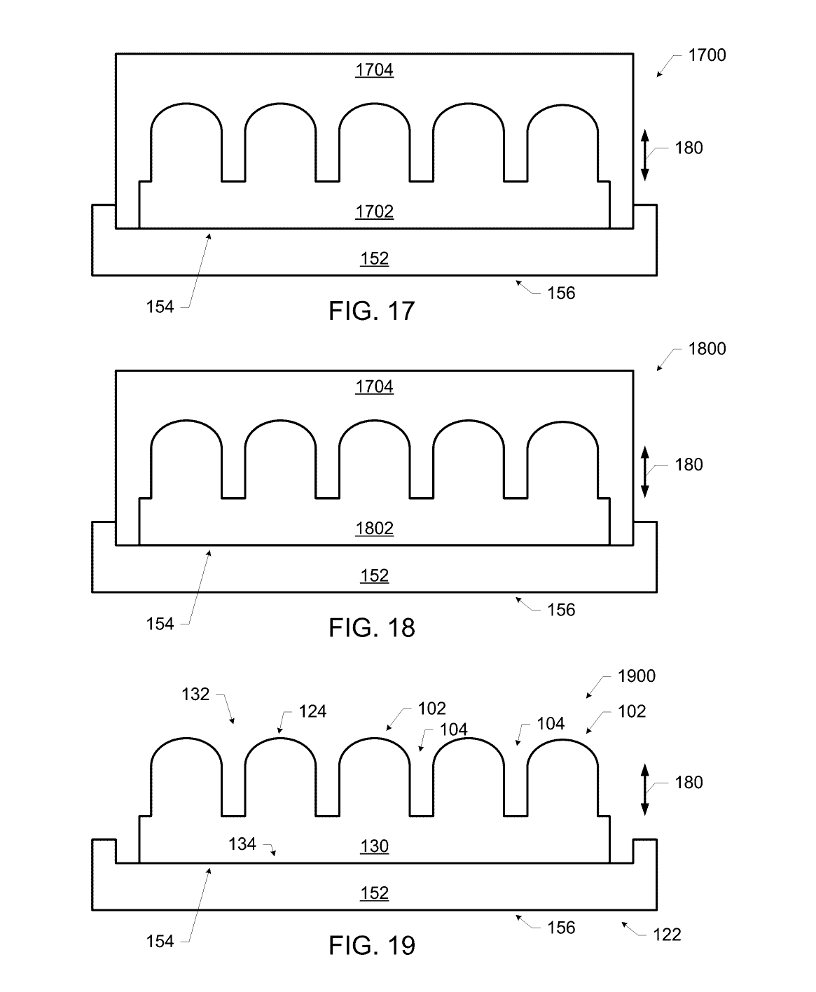

FIGS. 17-19 are side, cross-sectional views of assemblies at various stages in the manufacture of an embodiment of the die transport apparatus 100 of FIG. 8, in accordance with various embodiments. Although the stages illustrated by FIGS. 17-19 are shown as producing the die transport apparatus 100 of FIG. 8, this is simply illustrative, and the operations discussed below with reference to FIGS. 17-19 may be used to manufacture any suitable die transport apparatus. Additionally, although the various manufacturing operations discussed below with reference to FIGS. 17-19 are discussed in a particular order, the manufacturing operations may be performed in any suitable order.

FIG. 17 depicts the assembly 1700 having a mold 1704 in contact with a tray 152. The mold 1704 may be contoured to have an inverse pattern to the profile of the continuous adhesive material 130 of the die transport apparatus 100 of FIG. 8, and a void 1702 may be present between the mold 1704 and the tray 152.

FIG. 18 depicts the assembly 1800 subsequent to providing an adhesive material 1802 to the void 1702 of the assembly 1700 to fill the void. In some embodiments, the adhesive material 1802 may be a molten adhesive material that, when cooled, forms the continuous adhesive material 130. In some embodiments, the adhesive material 1802 may be injection molded as part of an overmolding process.

FIG. 19 depicts the assembly 1900 subsequent to removing the mold 1704 from the assembly 1800 after curing the adhesive material 1802 to form the continuous adhesive material 130 overmolded onto the tray 152. In particular, as discussed above with reference to FIG. 8, a first face 134 of the continuous adhesive material may be coupled to a first face 154 of the tray 152. The assembly 1900 and components thereof may take any of the forms discussed above with reference to the die transport apparatus 100 of FIG. 8.

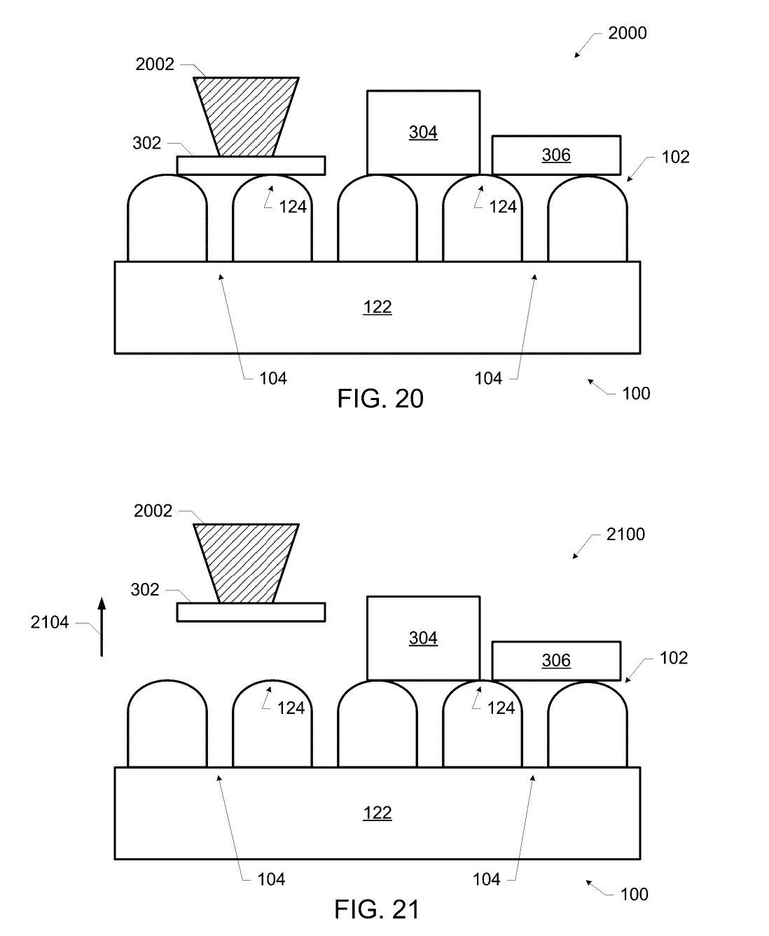

FIGS. 20-22 are side, cross-sectional views of various stages of operation in a method of processing an IC die, in accordance with various embodiments. Although the stages illustrated by FIGS. 20-22 are shown with reference to the die transport apparatus 100 of FIG. 2 and the transport arrangement 300 of FIG. 3, this is simply illustrative, and the operations discussed below with reference to FIGS. 20-22 may be used for testing an IC die utilizing any of the die transport apparatus disclosed herein.

FIG. 20 depicts an arrangement 2000 in which a contact portion 2002 (e.g., a vacuum nozzle) of a component placement system is brought into contact with the first die 302 and a vacuum is applied to secure the first die 302 to the contact portion 2002. The first die 302 is shown is disposed on a die transport apparatus 100 having adhesive areas 102 and a relief area 104 arranged such that the die 302 is in contact with one or more adhesive die contact surfaces 124 of the die transport apparatus 100. Other dies (such as the second die 304 and the third die 306) may also be disposed on the die transport apparatus 100.

FIG. 21 depicts an arrangement 2100 in which the contact portion 2002 of the component placement system applies a force to the first die 302 of the arrangement 2000 in a direction indicated by the arrow 2104 (opposite to the direction of the adhesive force between the die contact surface(s) 124 and the first die 302) to pick the first die 302 off the die transport apparatus 100. The component placement system may move the die to a test bed or other location for testing or other processing of the first die 302 after removing the first die 302 from the die transport apparatus 100.

FIG. 22 depicts arrangement 2200 in which the contact portion 2002 of the component placement system repositions the first die 302 on the die transport apparatus 100 (e.g., after testing or other processing). The first die 302 may be repositioned on the die transport apparatus 100 in the same location on the die transport apparatus 100 as was occupied by the first die 302 in the arrangement 2000 (FIG. 20), or the first die 302 may be repositioned to a new location. The first die 302 may be subsequently picked up, processed, and repositioned again as many times as desired. The second I 304 and/or the third die 306 may also be picked up, process, and repositioned as many times as desired.

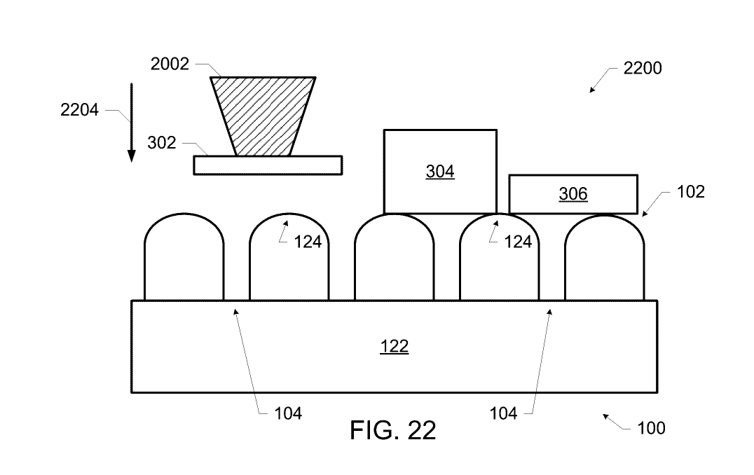

FIG. 23 is a flow diagram of a method 2300 of processing an IC die, in accordance with various embodiments. Although the operations discussed below with reference to the method 2300 (and the other methods disclosed herein) may be presented in a particular order, the various operations may be performed in any suitable order (or in parallel, as suitable) and may be repeated as suitable. Additionally, the operations of the method 2300 (and the other methods disclosed herein) may be illustrated with reference to the die transport apparatus 100, but this is simply for illustrative purposes, and any suitable die transport apparatus and die may be used in the performance of the method 2300.

At 2302, an IC die disposed on a die transport apparatus 100 may be provided. The die transport apparatus 100 may include multiple regularly arranged adhesive areas, wherein individual adhesive areas have a die contact surface. The die transport apparatus 100 may include relief areas recessed from the die contact surfaces. The IC die may be disposed on the die transport apparatus 100 such that the IC die is in contact with the die contact services of more than one of the multiple adhesive areas.

At 2304, the IC die may be picked off the die transport apparatus 100. The IC die may be picked off the die transport apparatus 100 by applying a force to the IC die in a direction opposite to an adhesive force between the IC die and the die contact surfaces of the more than one of the multiple adhesive areas.

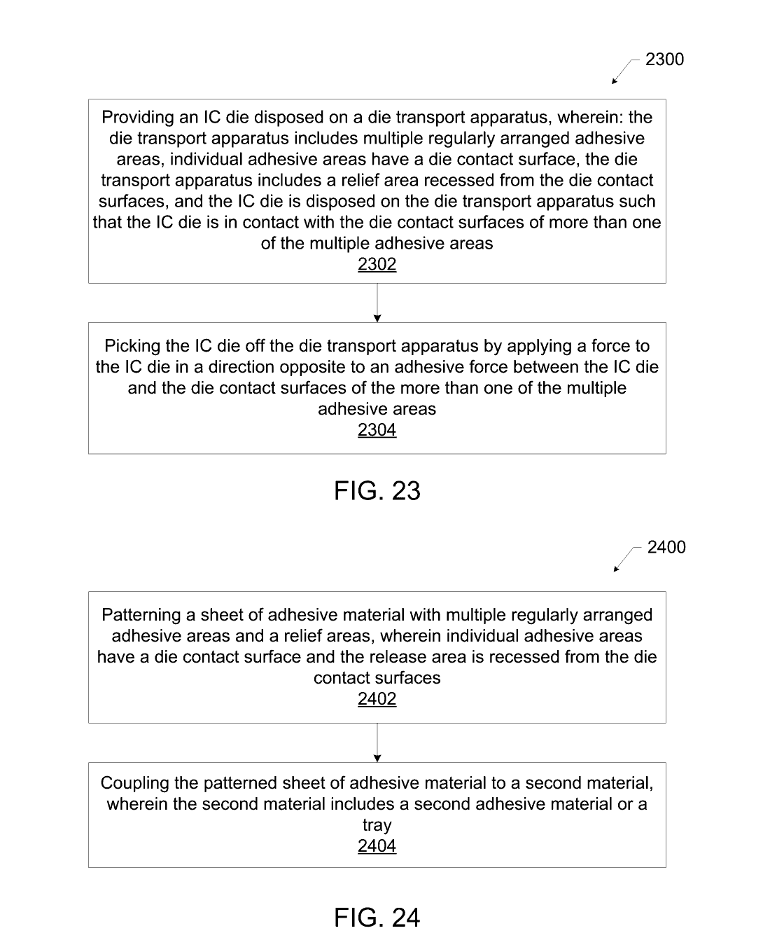

FIG. 24 is a flow diagram of a method 2400 of manufacturing a die transport apparatus, in accordance with various embodiments. The method 2400 may be used to manufacture any of the die transport apparatus 100 discussed above with reference to FIGS. 5-8, for example.

At 2402, a sheet of adhesive material may be patterned with multiple regularly arranged adhesive areas and a relief area. Individual adhesive areas may have a die contact surface and the release area may be recessed from the die contact surfaces. In some embodiments, patterning the sheet of adhesive material may include embossing a texture onto a first face of the sheet of adhesive material.

At 2404, the patterned sheet of adhesive material (formed at 2402) may be coupled to a second material. The second material may include a second adhesive material (e.g., the second adhesive material 142, coupled to the patterned sheet of adhesive material via a support film 136) or a tray (e.g., the tray 152). In some embodiments, the patterned sheet of adhesive material may be coupled directly to a tray. In some embodiments, the patterned sheet of adhesive material may be coupled to a tray via one or more intermediate layers (e.g., a support film 136 and a second adhesive material 142). In some embodiments, the patterned sheet of adhesive material may not be coupled to a tray.

In some embodiments, the die transport apparatus 100 may be cleanable to remove silicon and other debris from any adhesive or non-adhesive surfaces of the die transport apparatus 100. Examples of cleaning techniques that may be used with various embodiments include an air blow to dislodge foreign material, deionized water cleaning (with optional fine brushing), and tack roller cleaning (in which a stronger adhesive is used to “stick” away foreign material from adhesive surfaces of the die transport apparatus 100).

The following paragraphs provide examples of various ones of the embodiments disclosed herein.

Example 1 may include a die transport apparatus, comprising: a plurality of regularly arranged adhesive areas, wherein individual adhesive areas have a die contact surface; and a relief area recessed from the die contact surfaces.

Example 2 may include the die transport apparatus of example 1, wherein the plurality of adhesive areas and the relief area are different portions of a continuous adhesive material.

Example 3 may include the die transport apparatus of example 2, wherein the continuous adhesive material has a first face and a second face opposite the first face, the plurality of adhesive areas are located at the first face, and the die transport apparatus further comprises a support film coupled to the second face.

Example 4 may include the die transport apparatus of example 3, wherein the continuous adhesive material is formed of a first adhesive material, the support film has a first face and a second face opposite the first face of the support film, the first face of the support film is in contact with the second face of the continuous adhesive material, and the die transport apparatus further comprises a second adhesive material coupled to the second face of the support film.

Example 5 may include the die transport apparatus of example 4, wherein the second adhesive material has a first face and a second face opposite the first face of the second adhesive material, the first face of the second adhesive material is in contact with the second face of the support film, and the die transport apparatus further includes a tray coupled to the second face of the second adhesive material.

Example 6 may include the die transport apparatus of example 2, wherein the continuous adhesive material has a first face and a second face opposite the first face, the plurality of adhesive areas are located at the first face, and the die transport apparatus further comprises a tray coupled to the second face.

Example 7 may include the die transport apparatus of any of examples 1-6, wherein the relief area is not adhesive.

Example 8 may include the die transport apparatus of any of examples 1-6, wherein the relief area is adhesive.

Example 9 may include the die transport apparatus of any of examples 1-6, wherein individual adhesive areas have a profile with a curved portion.

Example 10 may include the die transport apparatus of example 9, wherein the curved portion has a height between 25 microns and 150 microns.

Example 11 may include the die transport apparatus of example 9, wherein the curved portion has a width between 0.5 millimeters and 2 millimeters.

Example 12 may include the die transport apparatus of example 9, wherein the curved portion is an upper portion and the profiles of the individual adhesive areas have lower portions including side walls.

Example 13 may include the die transport apparatus of example 12, wherein the vertical side walls have a height between 25 microns and 150 microns.

Example 14 may include the die transport apparatus of any of examples 1-6, wherein centers of the individual adhesive areas are spaced away from centers of their nearest neighbor adhesive areas by a distance between 0.5 millimeters and 3 millimeters.

Example 15 may include the die transport apparatus of any of examples 1-6, wherein the individual adhesive areas are hexagonally arranged.

Example 16 may include the die transport apparatus of any of examples 1-6, wherein the individual adhesive areas have a peak tack force between 15 and 150 grams.

Example 17 may include a transport arrangement for an integrated circuit (IC) die, comprising: a die transport apparatus, including: a plurality of regularly arranged adhesive areas, wherein individual adhesive areas have a die contact surface, and a relief area recessed from the die contact surfaces; and the IC die disposed on the die transport apparatus such that the IC die is in contact with the die contact surfaces of more than one of the plurality of adhesive areas.

Example 18 may include the transport arrangement of example 17, wherein the IC die is a first IC die, and wherein the transport arrangement further comprises: at least one additional IC die.

Example 19 may include the transport arrangement of example 18, wherein the first IC die has a first length and a first width, and wherein the at least one additional IC die includes at least one IC die having a length or a width that is different from the first length or the first width, respectively.

Example 20 may include a method of processing an integrated circuit (IC) die, comprising: providing an IC die disposed on a die transport apparatus, wherein: the die transport apparatus includes a plurality of regularly arranged adhesive areas, wherein individual adhesive areas have a die contact surface, the die transport apparatus includes a relief area recessed from the die contact surfaces, and the IC die is disposed on the die transport apparatus such that the IC die is in contact with the die contact surfaces of more than one of the plurality of adhesive areas; and picking the IC die off the die transport apparatus by applying a force to the IC die in a direction opposite to an adhesive force between the IC die in the die contact surfaces of the more than one of the plurality of adhesive areas.

Example 21 may include the method of example 20, further comprising: after picking the IC die off the die transport apparatus, repositioning the IC die on the die transport apparatus such that the IC die is in contact with the die contact surfaces of more than one of the plurality of adhesive areas; and after repositioning the IC die on the die transport apparatus, re-picking the IC die off the die transport apparatus; wherein the die contact services of the die transport apparatus are continuously exposed during the picking, repositioning, and re-picking.

Example 22 may include a method of manufacturing a die transport apparatus, comprising: patterning a sheet of adhesive material with a plurality of regularly arranged adhesive areas and a relief area, wherein individual adhesive areas have a die contact surface and the relief area is recessed from the die contact surfaces; and coupling the patterned sheet of adhesive material to a second material, wherein the second material includes a second adhesive material or a tray.

Example 23 may include the method of example 22, wherein patterning the sheet of adhesive material includes embossing a texture onto a first face of the sheet of adhesive material, wherein the sheet of adhesive material has a second face opposite the first face and wherein the sheet of adhesive material has a support film coupled to the second face.

Example 24 may include the method of example 23, wherein the second material includes the second adhesive material, and wherein coupling the patterned sheet of adhesive material to the second adhesive material includes performing a conversion process to couple the patterned sheet of adhesive material to the second adhesive material and to couple the second adhesive material to a release liner.

What is claimed is:

1. A die transport apparatus, comprising:
a plurality of regularly arranged adhesive areas, wherein individual adhesive areas have a die contact surface; and
a relief area recessed from the die contact surfaces.

2. The die transport apparatus of claim 1, wherein the plurality of adhesive areas and the relief area are different portions of a continuous adhesive material.

3. The die transport apparatus of claim 2, wherein the continuous adhesive material has a first face and a second face opposite the first face, the plurality of adhesive areas are located at the first face, and the die transport apparatus further comprises a support film coupled to the second face.

4. The die transport apparatus of claim 3, wherein the continuous adhesive material is formed of a first adhesive material, the support film has a first face and a second face opposite the first face of the support film, the first face of the support film is in contact with the second face of the continuous adhesive material, and the die transport apparatus further comprises a second adhesive material coupled to the second face of the support film.

5. The die transport apparatus of claim 4, wherein the second adhesive material has a first face and a second face opposite the first face of the second adhesive material, the first face of the second adhesive material is in contact with the second face of the support film, and the die transport apparatus further includes a tray coupled to the second face of the second adhesive material.

6. The die transport apparatus of claim 2, wherein the continuous adhesive material has a first face and a second face opposite the first face, the plurality of adhesive areas are located at the first face, and the die transport apparatus further comprises a tray coupled to the second face.

7. The die transport apparatus of claim 1, wherein the relief area is not adhesive.

8. The die transport apparatus of claim 1, wherein the relief area is adhesive.

9. The die transport apparatus of claim 1, wherein individual adhesive areas have a profile with a curved portion.

10. The die transport apparatus of claim 9, wherein the curved portion has a height between 25 microns and 150 microns.

11. The die transport apparatus of claim 9, wherein the curved portion has a width between 0.5 millimeters and 2 millimeters.

12. The die transport apparatus of claim 9, wherein the curved portion is an upper portion and the profiles of the individual adhesive areas have lower portions including side walls.

13. The die transport apparatus of claim 12, wherein the vertical side walls have a height between 25 microns and 150 microns.

14. The die transport apparatus of claim 1, wherein centers of the individual adhesive areas are spaced away from centers of their nearest neighbor adhesive areas by a distance between 0.5 millimeters and 3 millimeters.

15. The die transport apparatus of claim 1, wherein the individual adhesive areas are hexagonally arranged.

16. The die transport apparatus of claim 1, wherein the individual adhesive areas have a peak tack force between 15 and 150 grams.

17. A transport arrangement for an integrated circuit (IC) die, comprising:
a die transport apparatus, including:
a plurality of regularly arranged adhesive areas, wherein individual adhesive areas have a die contact surface, and
a relief area recessed from the die contact surfaces; and
the IC die disposed on the die transport apparatus such that the IC die is in contact with the die contact surfaces of more than one of the plurality of adhesive areas.

18. The transport arrangement of claim 17, wherein the IC die is a first IC die, and wherein the transport arrangement further comprises:
at least one additional IC die.

19. The transport arrangement of claim 18, wherein the first IC die has a first length and a first width, and wherein the at least one additional IC die includes at least one IC die having a length or a width that is different from the first length or the first width, respectively.

20. A method of processing an integrated circuit (IC) die, comprising:
providing an IC die disposed on a die transport apparatus, wherein:
the die transport apparatus includes a plurality of regularly arranged adhesive areas, wherein individual adhesive areas have a die contact surface,
the die transport apparatus includes a relief area recessed from the die contact surfaces, and
the IC die is disposed on the die transport apparatus such that the IC die is in contact with the die contact surfaces of more than one of the plurality of adhesive areas; and
picking the IC die off the die transport apparatus by applying a force to the IC die in a direction opposite to an adhesive force between the IC die in the die contact surfaces of the more than one of the plurality of adhesive areas.

21. The method of claim 20, further comprising:
after picking the IC die off the die transport apparatus, repositioning the IC die on the die transport apparatus such that the IC die is in contact with the die contact surfaces of more than one of the plurality of adhesive areas; and
after repositioning the IC die on the die transport apparatus, re-picking the IC die off the die transport apparatus;
wherein the die contact services of the die transport apparatus are continuously exposed during the picking, repositioning, and re-picking.

22. A method of manufacturing a die transport apparatus, comprising:
patterning a sheet of adhesive material with a plurality of regularly arranged adhesive areas and a relief area, wherein individual adhesive areas have a die contact surface and the relief area is recessed from the die contact surfaces; and
coupling the patterned sheet of adhesive material to a second material, wherein the second material includes a second adhesive material or a tray.

23. The method of claim 22, wherein patterning the sheet of adhesive material includes embossing a texture onto a first face of the sheet of adhesive material, wherein the sheet of adhesive material has a second face opposite the first face and wherein the sheet of adhesive material has a support film coupled to the second face.

24. The method of claim 23, wherein the second material includes the second adhesive material, and wherein coupling the patterned sheet of adhesive material to the second adhesive material includes performing a conversion process to couple the patterned sheet of adhesive material to the second adhesive material and to couple the second adhesive material to a release liner.
